(19) United States
(12) Patent Application Publication
(10) Pub. No.: US 2018/0220237 A1
(43) Pub. Date: Aug. 2, 2018

(54) POWER-OVER-ETHERNET ACTIVE SPEAKER

(71) Applicant: PERI, INC., irvine, CA (US)

(72) Inventor: Mohammad TABATABAI, Newport Coast, CA (US)

(21) Appl. No.: 15/748,094

(22) PCT Filed: Jul. 28, 2016
(86) PCT No.: PCT/US16/44568

§ 371 Date: Jan. 26, 2018

Related U.S. Application Data
(60) Provisional application No. 62/197,911, filed on Jul. 28, 2015.

(51) Int. Cl. H04R 9/02; H04R 3/02; H04R 1/02; H04L 12/10

(52) U.S. Cl. CPC H04R 9/02; H04R 3/02; H04R 1/025; H04R 2499/13; H04R 2201/028; H04R 2420/09; H04L 12/10

(57) ABSTRACT

A speaker system includes a speaker and control circuitry, wherein the control circuitry includes an Ethernet port, and wherein power to the control circuitry is supplied by an Ethernet connection to the Ethernet port. In some embodiments, digital audio data is also supplied by the Ethernet connection, and in other embodiments digital audio data is wirelessly supplied. In some embodiments, the control circuitry is mounted on a printed circuit board (PCB) and includes a digital to analog converter and an amplifier. In some embodiments the printed circuit board has a semi-annular shape and is mounted to the speaker around a transducer of the speaker. The speaker includes an electromagnetic shield surrounding portions of the transducer proximate to the printed circuit board.

### CROSS REFERENCE TO RELATED APPLICATIONS

This application claims priority to, and any other benefit of, U.S. Provisional Patent Application Ser. No. 62/197,911, filed Jul. 28, 2015 entitled “ETHERNET+ POE BASED ACTIVE SPEAKER WITH WI-FI INTEGRATION,” the entire disclosure of which is incorporated herein by reference as though fully recited herein.

### TECHNICAL FIELD

The present invention relates generally to speakers, and more specifically to a new generation of “active” speakers with integrated circuitry and power input.

### BACKGROUND OF THE INVENTION

Current speakers and drivers used in today's audio applications, installed and applied in, for example, automotive, home audio and portable electronics, are mainly composed of a transducer, magnet, cone/s and a suspension element. In the typical arrangement, electrical signals carry analog audio within a specified audio frequency range from a separate and remote audio amplifier. The analog signals are then applied to the transducer wires of the speaker through standard audio wires, which, traditionally, are a pair of stranded-coupled wires, varying in gauge and impedance, to impedance-match the amplifier to the speaker. Because all amplification and signal processing is performed remotely from the speaker itself (e.g., by a receiver or infotainment system), there is no need to provide additional power to the speakers.

This long-standing typical speaker-amplifier arrangement has several drawbacks. Because all speakers are connected to and receive signal from a single amplifier, it is difficult to achieve full customization of sound at each individual speaker location. Moreover, because amplification occurs remotely from the speakers, there is much higher incident of power loss and signal degradation after amplification and equalization and prior to actual sound output.

### SUMMARY

A speaker system combines audio processing and output into a single unit for increased audio quality and power and cost savings. In one embodiment a speaker system includes a speaker and control circuitry, and the control circuitry includes an Ethernet port. Power to the control circuitry is supplied by an Ethernet connection to the Ethernet port.

In another embodiment, a speaker system for an automobile includes a plurality of speaker units. Each speaker unit includes a speaker and an Ethernet port and power to each speaker unit is supplied by an Ethernet connection to its respective Ethernet port.

In a further embodiment, a speaker system includes a speaker having a transducer and further includes a printed circuit board. The printed circuit board includes an Ethernet port, a digital to analog converter, and an amplifier. The printed circuit board has a semi-annular shape and is mounted to the speaker around the transducer. The speaker further includes an electromagnetic shield surrounding portions of the transducer proximate to the printed circuit board. Power and digital audio data are supplied to the speaker system by an Ethernet connection to the Ethernet port.

### BRIEF DESCRIPTION OF THE DRAWINGS

These and other features and advantages of the present invention will become better understood with regard to the following description and accompanying drawings in which:

FIG. 1 illustrates a schematic diagram of an exemplary speaker system according to the present invention.

FIG. 2 illustrates an exemplary arrangement of a speaker system according to the present invention;

FIG. 3 illustrates another exemplary arrangement of a speaker system according to the present invention;

FIG. 4 illustrates a further exemplary arrangement of a speaker system according to the present invention;

FIG. 5 illustrates an exemplary an exemplary audio environment utilizing speaker systems according to the present invention.

### DETAILED DESCRIPTION

The present application discloses an active speaker with integrated circuitry and power input case for use in automotive, home audio and portable electronics applications. These and other features, described more fully herein, form a unique new “active” speaker that couples audio output components and signal processing components into a single integrated unit that has power and Ethernet connectivity through Power over Ethernet (PoE) and digital audio data on a single twisted pair or coaxial cable. This unique arrangement allows for easy modularity and customization in designing, installing and changing a sound system and provides for increased audio output quality and power savings.

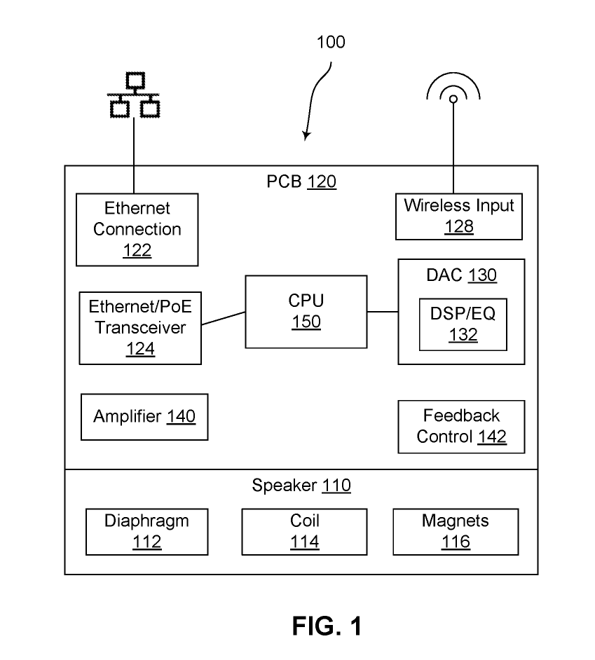

FIG. 1 is schematic diagram of an exemplary speaker system 100. The speaker system 100 includes an integrated speaker 110 and a printed circuit board assembly (PCBA) 120. The integrated speaker 110 includes typical components, including a diaphragm 112 and a transducer, e.g., wire coil 114 and a magnet 116. The diaphragm 112 maybe any suitable shape or size depending on the specific application. For example the diaphragm 112 may have a conical, dome or ribbon shape depending on the frequency range of the desired sound output. The diaphragm 112 may be made of any suitable material, for example metal, polymer, paper or wood, with a desired rigidity depending again on the frequency range of the desired sound output. It is further contemplated that the speaker 110 can be an array of speakers (e.g., of differing frequencies) all integrated with the single PCBA 120.

According to the several embodiments disclosed herein, the PCBA 120 can house a number of different components to provide a sound output signal the speaker 110. Several different integration arrangements between the PCBA 120 and speaker 110 and are discussed more fully below.

In order to provide power (and, in some embodiments, data) to the components of the PCBA 120, the PCBA 120 includes Ethernet connection circuitry 122. In one embodiment, the Ethernet connection circuitry 122 is configured to accept a standard Ethernet connection (IEEE 802.3), including Ethernet 10Base-t, 100Base-t, 1000Base-t or 10GBase-t. The Ethernet connection circuitry 122 may be configured to accept a coaxial cable input or a twisted-pair cable input (e.g., a “Cat 5” cable) or a single-pair twisted cable, but may also be configured to accept other Ethernet-compliant cables, such as a fiber optic cable (in embodiments with a separate, dedicated power-over-Ethernet port). In some embodiments, the Ethernet connection circuitry 122 is configured for a Power over Data Lines (PoDL) input (see, e.g., IEEE P802.3bu), which, unlike standard Ethernet, uses only single-pair channels and thus can save cost and space by using less wire. In further embodiments, the Ethernet connection 122 is configured for a BroadR-Reach connection, which is also a single-pair connection. In any of the above embodiments, the PCBA 120 may further include an Ethernet transceiver 124, which allows the components of the PCBA 120 to both receive and transmit data via the Ethernet connection circuitry 122. In a preferred embodiment, the Ethernet connection circuitry 122 operates in full-duplex mode, which allows the Ethernet connection circuitry 122 to simultaneously send and receive data to and from an Ethernet switch.

In some embodiments, the PCBA includes wireless connection circuitry 128. In some embodiments, the wireless connection circuitry 128 includes an antennae and circuitry for connection using a packet-switched protocol, such as IEEE 802.11a, IEEE 802.11b, IEEE 802.11g, IEEE 802.11n or IEEE 802.11ac (commonly referred to as WiFi). Other WiFi-based protocols may be used, such as Apple's AirPlay, Intel's WiFi Direct (WiDi) or Miracast. WiFi Audio allows streaming of lossless audio files, for example Apple Lossless (ALAC), Free Lossless Audio Codec (FLAC) and the like for highly enhanced audio quality. In some embodiments, the wireless connection circuitry 128 includes an antennae and circuitry for connection using a Bluetooth interface, i.e., complying with Bluetooth SIG standards, for example Bluetooth version 4.0. The wireless connection circuitry 128 may be, for example a Microchip Bluetooth APL module.

In one embodiment, the PCBA 120 includes a digital-to-analog converter (DAC) 130 to process digital audio signals coming from the Ethernet connection circuitry 122 or wireless connection circuitry 128. In one embodiment the DAC 130 is a programmable single-chip digital signal processor (DSP). In one embodiment, the DAC 130 further includes equalizer circuitry 132. In some embodiments, the equalizer circuitry 132 may be used to obtain active audio equalization by allowing a user to edit the DSP firmware via the wired connection 122 or wireless connection 124. For example, a user could use a home or automotive infotainment system to interact with the speaker system 100 and set equalizer values. In other embodiments, a user can communicate with speaker system 100 wirelessly using software installed a mobile device, such as a phone or tablet computer.

Whereas in a typical speaker arrangement, the electrical amplifier would exist remotely from the speaker (i.e., where the power source exists), the power/speaker integration of the present invention allows for an integrated amplifier 140 included on the PCBA 120. The amplifier 140 may be any suitable analog circuit for voltage gain, applied post processing and conversion, and may be a pre-built unit (chip) or a configuration of electrical components including operational amplifiers, capacitors, resisters, transistors and the like. In some embodiments, the amplifier is a digital amplifier applied to digital data prior to analog conversion.

In some embodiments, the PCBA further includes feedback/correction circuitry 142 that serves to reduce or modify the output of amplifier 140 to reduce distortion of the sound output at the speaker 110. For example, the feedback/correction circuitry 142 may lower the output of a certain frequency or range of frequencies that is significantly higher in the sound waveform.

Communication between the various components of the PCBA, including those described above, may be facilitated by a CPU 150. The CPU 150 may be any suitable microcontroller or microprocessor. Particularly, the CPU 150 may facilitate transfer of digital data packets from received from the Ethernet/PoE transceiver 124 to the DAC 130 for processing and conversion prior to output at the speaker 110.

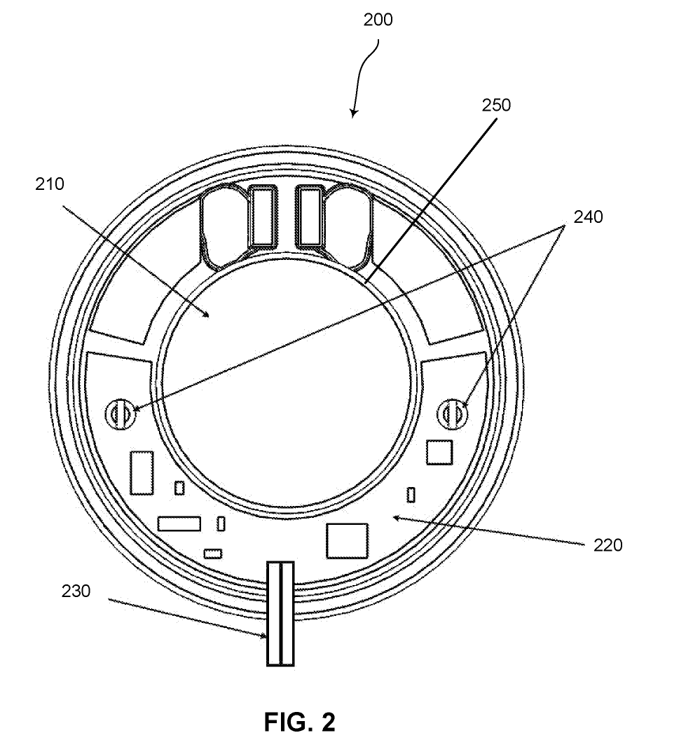

Turning now to FIG. 2, illustrated is a first exemplary arrangement of a speaker system 200 according to the present invention. In the exemplary speaker system 200, the PCBA 220 is mounted directly onto the backside of speaker 210. A twisted-pair or coaxial cable 230 connects to a remote Ethernet switch or physical layer Ethernet device (not shown) and provides power and communication to the speaker system 200. As described above, in some embodiments the PCBA 220 may include a wireless module for receiving audio data. In the embodiment shown, the PCBA 220 is mounted to the speaker 110 using a pair of fasteners 240, for example screws, bolts or the like. One should appreciate that the number and arrangement of the fasteners is exemplary, and there may be only one fastener or more than two fasteners, and the placement of the fasteners may vary. Moreover, in addition to or in lieu of using fasteners, the PCBA 320 may be connected to the speaker 210 using adhesive (e.g., glue or resin) and/or via weld or solder.

In the exemplary embodiment of speaker system 200, the PCBA 220 has a general “U” shape in order to fit around the back of a speaker 210 and its transducer components. The PCBA 220 can also be described being annular or semi-annular or as having a central recess to accommodate the back of the speaker 210. In some embodiments, in order to inhibit any potential electrical or magnetic interference between the transducer of the speaker 210 the electronic components of the PCBA 220, the transducer of the speaker 210 may include a shielding or cap 250 configured to prevent electromagnetic interference. Suitable material for electromagnetic interference shielding 250 include carbon based materials such as graphite and graphene, as well as metals such as silver, copper, nickel or aluminum, glass, elastomers, or combinations thereof (e.g., via plating).

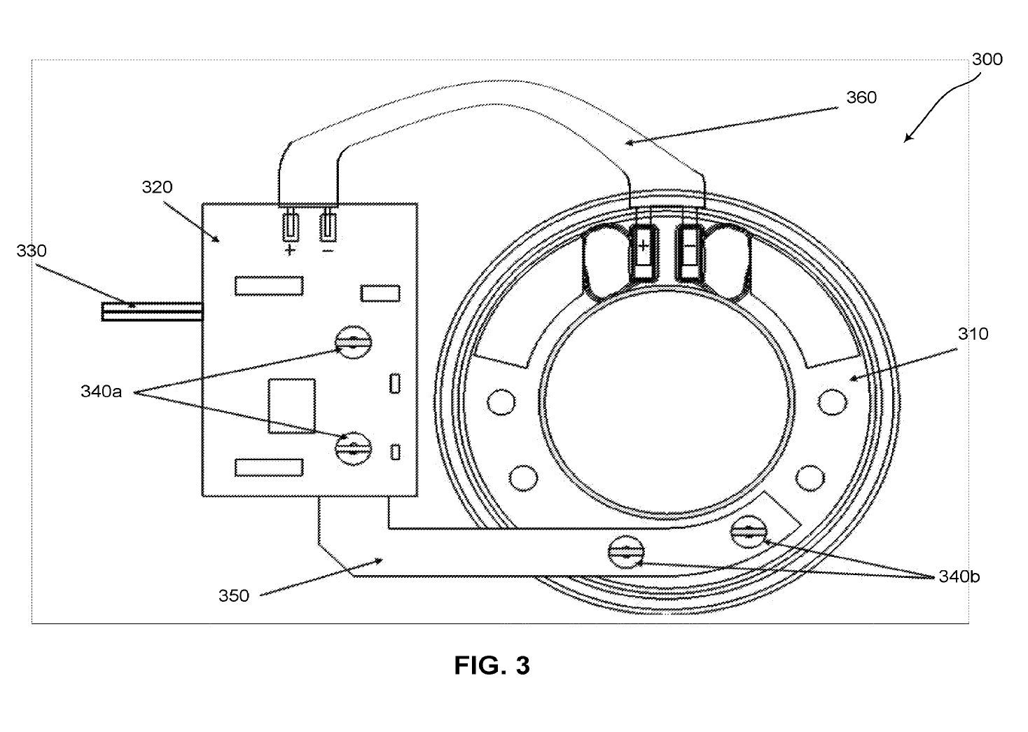

In another exemplary embodiment of a speaker system 300, as shown in FIG. 3, a PCBA 320 is mounted to a speaker 310 using a mounting bracket 350, rather than direct mounting as described in the previous embodiment. In the speaker system 300, a twisted-pair or coaxial cable 330 connects to a remote Ethernet switch or physical layer Ethernet device (not shown) and provides power and communication to the PCBA 320. As described above, in some embodiments the PCBA 320 may include a wireless module for receiving audio data. An analog audio signal (after signal processing, e.g., DAC conversion, equalization, amplification, feedback control, etc.) is transmitted from the PCBA 320 to the speaker 310 via cable 360. The cable 360 may be a twisted pair cable or a coaxial cable.

As shown in FIG. 3, the speaker 310 and PCBA 320 are both connected to the mounting bracket 350 using fasteners 340a and 340b. Again, one would appreciate that the number and arrangement of the fasteners is exemplary, and there may be only one fastener or more than two fasteners, and the placement of the fasteners may vary. Moreover, in addition to or in lieu of using fasteners, the PCBA 320 and/or speaker 310 may be connected to the mounting bracket 350 using adhesive (e.g., glue or resin) and/or via weld or solder. It should also be appreciate the present invention is not limited to the arrangement shown in FIG. 3. For example, the PCBA 320 may be mounted so that it resides directly behind the speaker 310 (with a gap in between), or it may be adjacent to the speaker 310, above or below, etc.

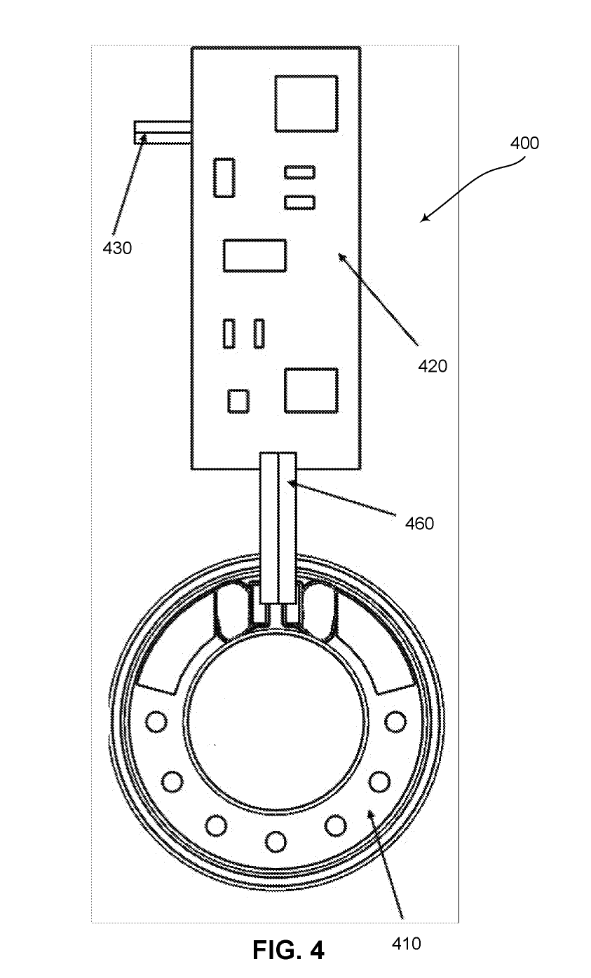

FIG. 4 shows yet another embodiment of a speaker system 400 according to the present invention. The embodiment includes a speaker 410 and PCBA 420 that are connected only via cable 460. The cable 460 may be a twisted pair standard audio cable. The cable 460 carries an analog audio signal (after signal processing, e.g., DAC conversion, equalization, amplification, feedback control, etc.) at the PCBA 420. In the speaker system 400, a twisted-pair or coaxial cable 430 connects to a remote Ethernet switch or physical layer Ethernet device (not shown) and provides power and communication to the PCBA 420. As described above, in some embodiments the PCBA 420 may include a wireless module for receiving audio data.

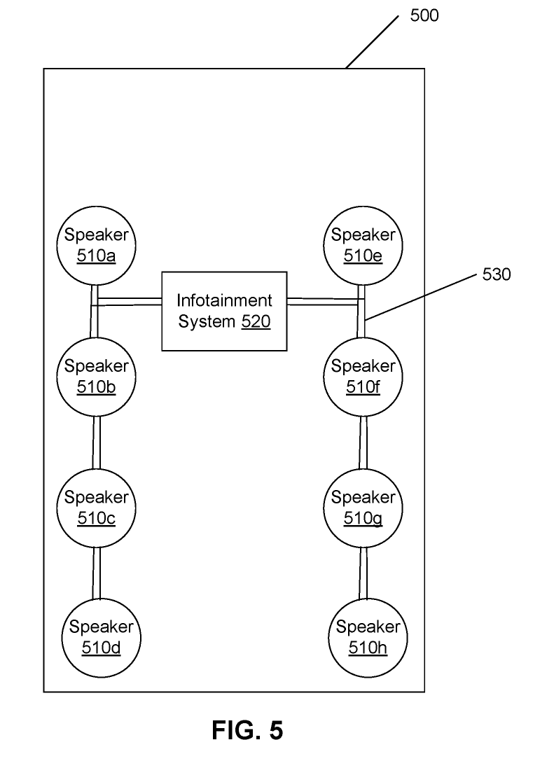

The speaker systems according to the present invention are designed such that they can be combined and used in a pre-installed or modular fashion. For example, FIG. 5 shows a sound system in an exemplary automobile 500 that utilizes speaker systems 510a-510h. The exemplary automobile 500 further includes an infotainment system 520. The infotainment system 520 may be any suitable computer that includes user-interactive functions such music and video selection, configuration thereof (e.g., volume and sound equalization) as well as other features associated with the automobile 500 such as maps, GPS, vehicle diagnostics, temperature controls, internet access, Bluetooth device paring, etc. The infotainment system 520 may also include an Ethernet switch or multiple physical layer Ethernet devices for controlling communications over the twisted-pair Ethernet cable 530 to the speakers 510a-510h. The speakers 510a-510h may communicate back to the infotainment system 520 using a full-duplex Ethernet mode. The Ethernet cable 530 also provides power to the speakers systems 510a-510h, as described in the exemplary embodiments above. In some embodiments, the Ethernet cable 530 provides only power, and data is transmitted to the speakers 510a-510h via wireless communication as described above or another dedicated Ethernet line (not shown).

In one embodiment, each speaker unit 510a-510h is capable of acting as a physical layer Ethernet device and routing Ethernet transmission for the entire system, including the remaining speaker units 510a-510h.In this embodiment one speaker unit may act as a master unit and the others as slave units. In this embodiment a user may control the master/slave status of units 510a-510h via the infotainment system 520 or via wireless connection to a software application installed on a mobile device.

By using the speakers 510a-510h in a modular fashion, a user can tailor each individual speaker system to create a personalized sound environment. For example, the various speaker embodiments described above (which all include a PCBA with various components for enhancing signal quality) can be re-arranged or replaced to suit a user's needs. A user can easily place speaker systems adapted for specific frequency ranges at specific locations for optimum sonic experience.

Moreover, it should be appreciated that using the arrangement of the present invention, a digital signal is supplied to each speaker prior to processing and amplification. By contrast, in the typical arrangement, all processing and amplification for all speakers occurs at a central location and is then transmitted to all speakers. Accordingly, there is signal degradation and interference prior to output. Therefore, the output quality of the arrangement disclosed herein is superior, as there is little to no distance between processing and output at each speaker.

In a further embodiment, digital sound data is transmitted wirelessly to each speaker 510a-510h as described above. In this embodiment, each speaker can wirelessly communicate with each other speaker in order to provide perfect sonic synchronization between the set of speakers 510a-510h.

While the present invention has been illustrated by the description of embodiments thereof and while the embodiments have been described in considerable detail, it is not the intention of the applicants to restrict or in any way limit the scope of the appended claims to such detail. Additional advantages and modifications will readily appear to those skilled in the art. Moreover, elements described with one embodiment may be readily adapted for use with other embodiments. Therefore, the invention, in its broader aspects, is not limited to the specific details, the representative apparatus and/or illustrative examples shown and described. Accordingly, departures may be made from such details without departing from the spirit or scope of the applicants' general inventive concept.

We claim:

1. A speaker system comprising a speaker and control circuitry, wherein the control circuitry comprises an Ethernet port, and wherein power to the control circuitry is supplied by an Ethernet connection to the Ethernet port.

2. The speaker system of claim 1, wherein digital audio data is supplied to the control circuitry by the first Ethernet connection to first Ethernet port.

3. The speaker system of claim 1, the control circuitry further comprising wireless connection circuitry, wherein digital audio data is supplied to the control circuitry by a wireless signal received by the wireless connection circuitry.

4. The speaker system of claim 1, the control circuitry further comprising a digital-to-analog converter.

5. The speaker system of claim 4, the digital-to-analog converter comprising a digital signal processor with active equalizer circuitry.

6. The speaker system of claim 1, the control circuitry further comprising amplifier circuitry.

7. The speaker system of claim 1, the control circuitry further comprising circuitry configured to amplify an audio signal.

8. The speaker system of claim 1, the control circuitry further comprising circuitry configured to correct feedback in an audio signal.

9. The speaker system of claim 1, wherein the control circuitry is mounted on a printed circuit board.

10. The speaker system of claim 9, wherein the printed circuit board is mounted directly on the speaker.

11. The speaker system of claim 10, wherein the printed circuit board has a semi-annular shape.

12. The speaker system of claim 10, wherein the printed circuit board has an annular shape.

13. The speaker system of claim 9 wherein the printed circuit board is mounted to the speaker via a mounting bracket.

14. The speaker system of claim 9, the speaker further comprising a transducer and an electromagnetic shield surrounding portions of the transducer proximate to the printed circuit board.

15. A speaker system for an automobile comprising a plurality of speaker units, each speaker unit comprising a speaker and an Ethernet port, wherein power to each speaker unit is supplied by an Ethernet connection to its respective Ethernet port.

16. The speaker system of claim 15, wherein digital audio data is supplied to each speaker unit via the Ether net connection to its respective Ethernet port.

17. The speaker system of claim 15, each speaker unit further comprising wireless connection circuitry, wherein digital audio data is supplied to each speaker unit by a wireless signal received by its respective wireless connection circuitry.

18. The speaker system of claim 17, wherein each speaker unit is configured to communicate wirelessly with each other speaker and to synchronize audio output with each other speaker

19. A speaker system comprising:
a speaker having a transducer;
a printed circuit board having
an Ethernet port,
a digital to analog converter, and
an amplifier;
wherein the printed circuit board has a semi-annular shape and is mounted to the speaker around the transducer;
wherein the speaker further comprises an electromagnetic shield surrounding portions of the transducer proximate to the printed circuit board; and
wherein power and digital audio data are supplied to the speaker system by an Ethernet connection to the Ethernet port.
